(19) United States
(12) Patent Application Publication
(10) Pub. No.: US 2009/0288608 A1
(43) Pub. Date: Nov. 26, 2009

(54) Livestock feed apparatus

(76) Inventor: D. Vernon Dalton, Wells, NV (US)

Correspondence Address: THORPE NORTH & WESTERN, LLP., P.O. Box 1219, SANDY, UT, 84091-1219, US

(21) Appl. No.: 12/431,092

(22) Filed: Apr. 28, 2009

Related U.S. Application Data
(60) Provisional application No. 61/048,379, filed on Apr. 28, 2008.

(51) Int. Cl. A01K 5/00

(52) U.S. Cl. 119/57.91

(57) ABSTRACT

A portable livestock feeding apparatus and related methods for efficiently distributing livestock feed are disclosed and described. The livestock feeding apparatus includes at least one conveyor system, a cutting mechanism, a mixing system, and a dispensing system. The conveyor system transports the livestock feed from a receiving end of the conveyor system to a dispensing end of the conveyor system where the cutting mechanism and mixing system are located. The cutting mechanism is configured to substantially horizontally cut the livestock feed along at least two independent cutting zones. The mixing system is located between the cutting mechanism and the dispensing end of the conveyor system and mixes and loosens the livestock feed. Following the mixing system, the dispensing system can dispense the livestock feed from the apparatus.

### RELATED APPLICATION

This application claims the benefit of U.S. Provisional Patent Application No. 61/048,379, filed Apr. 28, 2008, entitled “Livestock Feed Apparatus”, and which is incorporated herein by reference.

### FIELD OF THE INVENTION

This invention relates to a livestock feeding apparatus which is capable of efficiently dispensing hay, silage, or other baled livestock feed. The invention is particularly useful when used with wet or relatively fresh hay.

### BACKGROUND

Livestock are regularly fed baled feed, particularly during the winter months. Such livestock feed can be dispensed by a variety of methods including manually with a pitchfork or through an automatic dispensing system. Although many automated dispensing systems enhance the efficiency of the distribution process, many of such systems use rotating beaters or doffers to break up the baled feed. Unfortunately, such systems can be susceptible to clogging when the baled feed gets wrapped around the rotating beaters or doffers. These problems are significantly aggravated when using wet and/or low quality feed. As such, a research into efficient distribution systems which avoid clogging continues.

### SUMMARY

The present invention provides for a portable livestock feeding apparatus for efficiently distributing livestock feed. In one aspect, the livestock feeding apparatus includes at least one conveyor system, a cutting mechanism, a mixing system, and a dispensing system. The conveyor system transports the livestock feed from a receiving end of the conveyor system to a dispensing end of the conveyor system. The cutting system is disposed proximate the dispensing end of the conveyor system and is configured to substantially horizontally cut the livestock feed with a blade in at least two independent cutting zones. The mixing system is disposed between the cutting mechanism and the dispensing end of the conveyor system and mixes and loosens the livestock feed. Following the mixing system, the dispensing system dispenses the livestock feed from the apparatus.

A method of reducing or preventing clogging of a hay processing apparatus is also described. The method includes the steps of providing a livestock feed processing apparatus and incorporating a cutting mechanism into the livestock feed processing apparatus. The livestock feed processing apparatus includes a conveyor system for transporting livestock feed from a receiving end of the conveyor system to the dispensing end of the conveyor system and has a plurality of horizontally oriented tubular shredders or mixers proximate the dispensing end of the conveyor system. The cutting mechanism is disposed between the receiving end of the conveyor system and the tubular shredders of the livestock feed processing apparatus. The cutting mechanism is configured to substantially horizontally cut the livestock feed in at least two independent cutting zones such that the livestock feed is cut into segments no greater than 14 inches in length.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF DRAWINGS

FIG. 1 is a side-view schematic of an embodiment of the portable livestock feed apparatus.

FIG. 2 is a back-view schematic of an embodiment similar to that shown in FIG. 1.

FIG. 3 shows a blow-up of the site on FIG. 2 in which the bandsaw blade 24 passes through the mechanical comb 26 prior to passing over the roller wheel 19.

These figures are provided merely for convenience in describing specific embodiments of the invention. Alteration in dimension, materials, and the like, including substitution, elimination, or addition of components can also be made consistent with the following description and associated claims.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It must be noted that, as used in this specification and the appended claims, the singular forms “a,” “an,” and “the” include plural referents unless the context clearly dictates otherwise. Thus, for example, reference to “a cutting system” includes one or more of such systems, and reference to “a blade” includes reference to one or more of such blades.

Definitions

In describing and claiming the present invention, the following terminology will be used in accordance with the definitions set forth below.

As used herein, “substantial” or “substantially” when used in reference to a quantity or amount of a material, or a specific characteristic thereof, refers to an amount that is sufficient to provide an effect that the material or characteristic was intended to provide. Therefore, “substantially horizontal” when referring to the orientation of a particular component, refers to an orientation of the component which is within a few degrees of being horizontal.

The term “livestock feed” refers generally to any baled or compacted plant material used in livestock feeding including but not limited to alfalfa, grass, clover, silage, straw, and the like.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Any steps recited in any method or process claims may be executed in any order and are not limited to the order presented in the claims unless otherwise stated. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

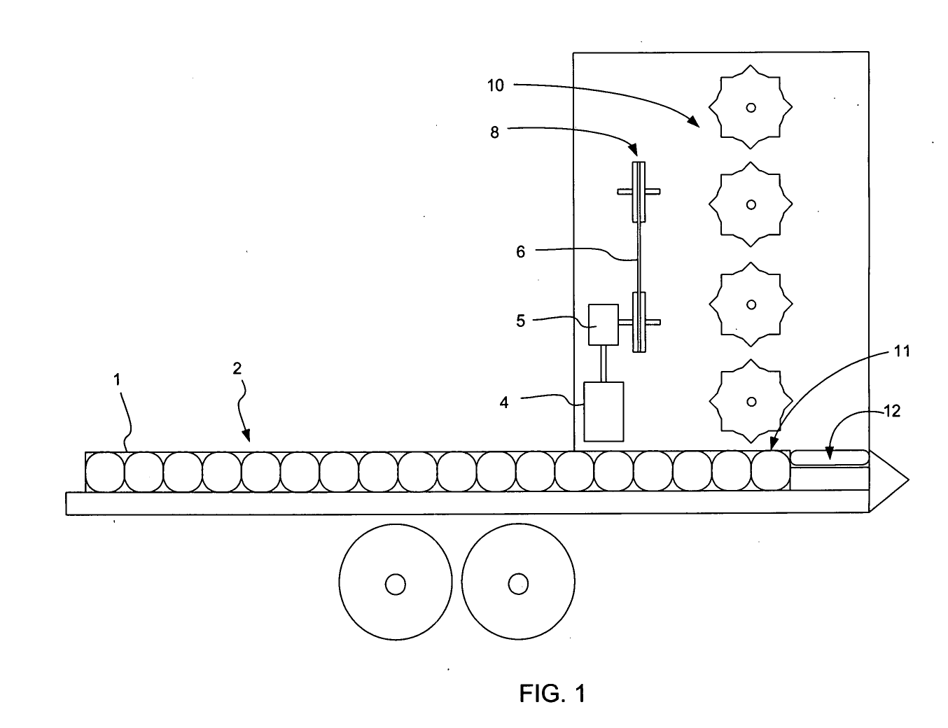

The present invention includes both a method and associated apparatus for effectively and efficiently distributing livestock feed. FIG. 1 shows a portable livestock feed apparatus which includes a conveyor system 2, a cutting mechanism 8, a mixing system 10, and a dispensing system 12. The conveyor system 2 has a receiving end 1 and a dispensing end 11 and is configured to transport the livestock feed from the receiving end to the dispensing end. The conveyer system can be any suitable mechanism which moves feed along its length. Non-limiting examples of suitable conveyors can include belt conveyors, chain-type conveyors, roller conveyors, and the like. As the livestock feed travels toward the dispensing end 11 of the conveyor system 2 it passes through a cutting mechanism 8 which is located near the dispensing end 11 of the conveyor system 2.

The cutting mechanism 8 is configured to substantially horizontally cut the livestock feed with a blade, along at least two independent cutting zones 18. The blade can be a bandsaw blade 6, although other blades could be used such as a reciprocating blade. The cutting edge or teeth of the blade can be oriented facing towards the receiving end 1. Thus, as the feed approaches it is cut and passes into the mixing system 10.

After the livestock feed is cut, a mixing system 10 located between the cutting mechanism 8 and the dispensing end 11 of the conveyor system breaks up and mixes the livestock feed. After the livestock feed is mixed it passes from the conveyor system to a dispensing system 12 which is located at the dispensing end 11 of the conveyor system 2 near the mixing system 10. The dispensing system 12 is configured to dispense the livestock feed from the apparatus to an area accessible by the livestock, such as the ground, troughs, or other feed receptacles.

The conveyor systems used in the present invention can be of any variety so long as they are capable of transporting the livestock feed from the receiving end to the dispensing end of the conveyor system. Non-limiting examples of various conveyor systems include rolled conveyors, solid, mesh, or linked conveyor belts, or other conveyor type systems. The conveyor system can include multiple conveyors which run in parallel or can include multiple conveyors oriented in series end-to-end. Parallel multi-conveyor systems are capable of transporting side-by-side livestock feed of different or the same quality or type at different rates, thereby providing different livestock feed ratios. This ability allows the system to generate efficient mixes of livestock feeds depending on the quality and type of feed provided.

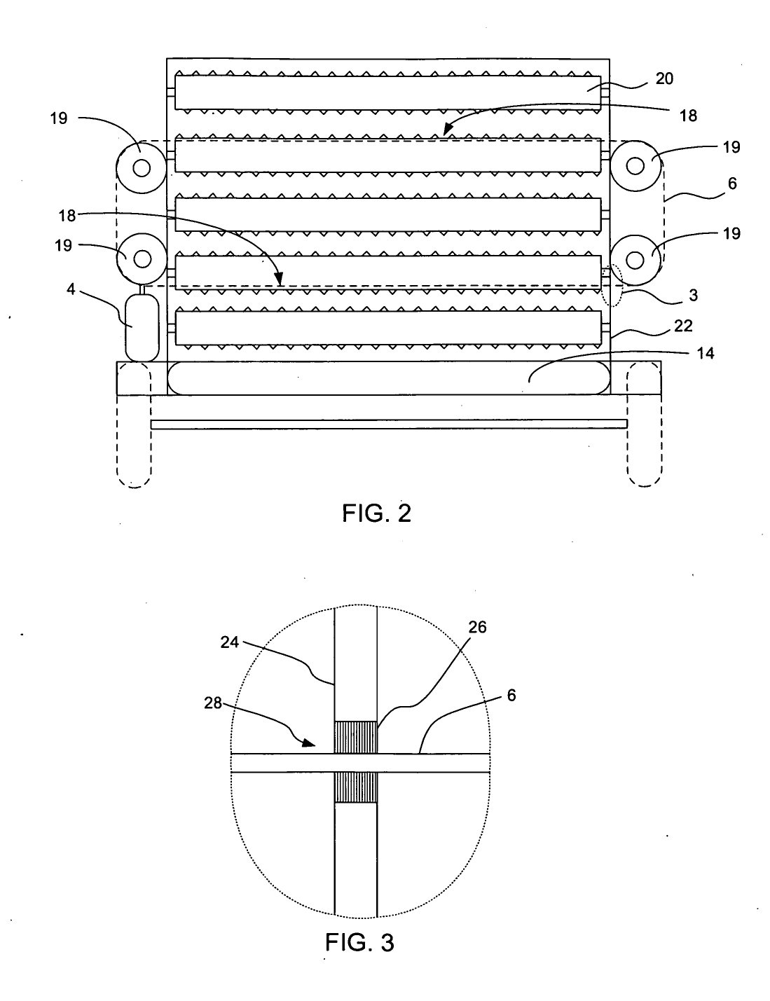

As the livestock feed moves from the conveyor system receiving end toward the conveyor system dispensing end, the livestock feed passes through the cutting mechanism and the mixing system. The cutting mechanism generally includes at least two cutting zones. In one aspect, the cutting mechanism can include three cutting zones. The cutting zones are areas in which the livestock feed is cut with a substantially horizontal cut by a moving blade, such as a bandsaw blade. FIG. 2 shows one embodiment and configuration for the cutting zones 18 adjacent the bandsaw blade 16. In the embodiment shown in FIG. 2, cutting is accomplished by a single bandsaw blade 16 which follows a roughly rectangular closed path. When a bandsaw blade is used, the cutting mechanism can also include at least two roller wheels 19 around which the bandsaw blade can revolve. FIG. 2 illustrates two sets of roller wheels, one on each end of the mechanism, to allow for increased space between passes of the blade. These roller wheels can optionally have a vertically adjustable position in order to adjust tension, allow for replacement of the blade, and/or optimize the vertical cut space across the feed. For example, decreasing the distance between the roller wheels in ether or both pairs can allow for loosening the blade for replacement or allowing a narrower cutting gap between blade passes. The roller wheels 19 are oriented outside the cutting zone 18 in order to avoid the livestock feed passing through the cutting mechanism. The bandsaw blade can be powered by at least one motor 4. FIG. 1 also shows an optional gear box 5 which can be used to transfer rotational motion from the motor 4 to at least one of the roller wheels, depending on the orientation of the motor. When two or more bandsaw blades are used in the cutting system, each blade can be independently powered or driven by a common motor.

When a bandsaw blade is used in the cutting system, the bandsaw blade can be guided by a plurality of mechanical guides which help maintain the bandsaw blade in the cutting zone. Generally, any form of guide can be used such as, but not limited to, a wheeled guide, fixed-plate guide, or ball-bearing guide. The mechanical guides help maintain the bandsaw blade in a substantially linear configuration as it stretches across the cutting zone and cuts the livestock feed. In one embodiment, the mechanical guides can be present on supporting members which run parallel to the bandsaw blade in each of the cutting zones. The supporting members can provide lateral support for the mechanical guides and the bandsaw blade during the cutting of the livestock feed.

Optional side spacers can be provided inside the cutting and mixing chassis 22. Such spacers can be oriented and sized based on the bale size in order to maintain the feed aligned horizontally into the cutting zones and to reduce or prevent excessive feed material from being pulled against the side walls of the chassis 22 and possibly into the roller wheels 19.

The cutting mechanism can include a mechanical comb located between the roller wheels 19 and the cutting zone. One alternative of a suitable mechanical comb 26 is shown in FIG. 3. In this embodiment, the mechanical comb can be a plate having a narrow slot therein through which the bandsaw blade passes through after leaving the cutting zone but prior to passing over the roller wheels. In FIG. 3, the mechanical comb 26 can include a broom-like bristles which brush the bandsaw blade 6 and clean the bandsaw blade prior to it passing over the roller wheels. The mechanical comb 26 can prevent clogging of the roller wheels by livestock feed that may become entangled with or attached to the bandsaw blade 6 during the cutting process. In this embodiment, the mechanical comb 26 can be directly attached to an aperture 28 in the chassis wall 24. Other mechanical combs can include, but are not limited to, a resilient metal plate which acts to scrape the blade clean, or the like.

When the portable livestock feed apparatus is configured as shown in FIG. 2, the single bandsaw blade 16, can simultaneously cut the livestock feed along the two independent cutting zones 18. The cutting zones 18 of the cutting mechanism can be configured to cut the livestock feed into segments having a length of no greater than about 14 inches. The cutting of the livestock feed into segments having relatively short lengths, e.g. less than 14 inches, facilitates better mixing of the livestock feed by the mixing system and can reduce wrapping or entanglement of the feed in the subsequent mixing system. The shorter feed segments are less prone to clogging the mixing system and dispensing system of the portable livestock feed apparatus which increases the effectiveness and efficiency of the apparatus in distributing the livestock feed. The apparatus of the present invention can generally experience reduced clogging as compared to a similar apparatus which does not have a cutting mechanism in addition to the mixing system.

After being cut by the cutting mechanism, the livestock feed is mixed by the mixing system. The mixing system can be of any type or configuration known in the art. In one embodiment, the mixing system can include a plurality of tubular components 20 which have protrusions sticking out from their surfaces. These tubular components can be referred to as shredders or mixers and can be configured to spin about their longitudinal axis. The spinning along their axis facilitates the breaking up and mixing the livestock feed as it passes from the cutting mechanism to the mixing system. These mechanisms can have some degree of shearing or cutting action but is primarily designed to break apart the feed and separate the feed into a loose mass which can be readily distributed. The rate of spin can be adjusted to compensate for various feed rates and other conditions.

As discussed above, after passing the through the mixing system, the livestock feed is dispensed from the portable livestock feed apparatus by the dispensing system. As the cut and mixed feed exits the mixing system it can be directed towards the dispensing system. This can be accomplished by movement of the conveyor 2 and/or the spinning action of the mixing tubular components 20. The dispensing of the feed can be done in any manner or by any means. For example, in one embodiment, the portable livestock feed apparatus can be dispensed out at least one side of the portable livestock feed apparatus. In another embodiment, the portable livestock feed apparatus can be configured to dispense the livestock feed out the front of the apparatus. This can be accomplished by a conveyor belt oriented substantially perpendicular to the feed belt such that as mixed materials fall from the mixing system opposite the blades, the mixed materials fall onto the conveyor which transports the same out the side of the apparatus to a suitable feeding location.

The portable livestock feed apparatus of the present invention can be configured to be attached to a self-propelled vehicle or to be towed behind such a vehicle on a wheeled trailer. Additionally, the livestock feed apparatus of the present invention can be scaled to various sizes and configurations so long as the overall principles of the invention remain the same.

It is to be understood that the above-referenced embodiments are illustrative of the application for the principles of the present invention. Numerous modifications and alternative arrangements can be devised without departing from the spirit and scope of the present invention while the present invention has been shown in the drawings and described above in connection with the exemplary embodiment(s) of the invention. It will be apparent to those of ordinary skill in the art that numerous modifications can be made without departing from the principles and concepts of the invention as set forth in the claims.

What is claimed is:

1. A portable livestock feed apparatus comprising:
at least one conveyor system for transporting a livestock feed from a receiving end of the conveyor system to a dispensing end of the conveyor system;
a cutting mechanism disposed proximate the dispensing end of the conveyor system, wherein the cutting mechanism is configured to substantially horizontally cut the livestock feed with a blade along at least two independent cutting zones;
a mixing system disposed between the cutting mechanism and the dispensing end of the conveyor system and being configured to separate and mix the cut livestock feed; and
a dispensing system disposed at the dispensing end of the conveyor system proximate the mixing system, said dispensing system being configured to dispense the cut livestock feed from the apparatus.

2. An apparatus as in claim 1, wherein the cutting zones of the cutting mechanism are configured to cut the livestock feed into segments having a length of no greater than 14 inches.

3. An apparatus as in claim 1, wherein the cutting mechanism includes at least one bandsaw blade.

4. An apparatus as in claim 3, wherein the cutting mechanism is configured such that a single bandsaw blade simultaneously cuts the livestock feed at the two independent cutting zones.

5. An apparatus as in claim 3, wherein the cutting mechanism is configured such that a separate bandsaw blade cuts the livestock feed at each independent cutting zone.

6. An apparatus as in claim 3, wherein the cutting mechanism includes at least two roller wheels around which the bandsaw blade revolves, said roller wheels being disposed outside the cutting zones.

7. An apparatus as in claim 6, wherein the cutting mechanism further includes a mechanical comb present between the roller wheels and the cutting zone, said mechanical comb being configured to reduce or prevent contact between the livestock feed and the roller wheels.

8. An apparatus as in claim 7, wherein the mechanical comb is a plate having a narrow slot therein, said plate being configured such that the bandsaw blade passes through the narrow slot after leaving the cutting zone but prior to passing over the roller wheels.

9. An apparatus as in claim 3, wherein the bandsaw blade is guided by a plurality of mechanical guides which help maintain the bandsaw blade in the cutting zone.

10. An apparatus as in claim 9, wherein the mechanical guides are supported by a supporting member which runs parallel to the bandsaw blade in each of the cutting zones.

11. An apparatus as in claim 3, wherein the mechanical guides are ball-bearing or wheeled guides.

12. An apparatus as in claim 1, wherein the cutting mechanism includes three independent cutting zones.

13. A method of reducing or preventing clogging of a livestock feed processing apparatus, comprising:
providing a livestock processing apparatus, said livestock processing apparatus having a conveyor system configured for transporting livestock feed from a receiving end of the conveyor system to the dispensing end of the conveyor system and having a plurality of horizontally oriented tubular shredders proximate the dispensing end of the conveyor system;
disposing a cutting mechanism between the receiving end of the conveyor system and the tubular shredders, said cutting mechanism disposed proximate the dispensing end of the conveyor system, wherein the cutting mechanism is configured to substantially horizontally cut the livestock feed with a blade at at least two independent cutting zones such that the livestock feed is cut into segments no greater than 14 inches in length.

14. A method as in claim 13, wherein the cutting zones of the cutting mechanism includes at least one bandsaw blade.

15. A method as in claim 13, wherein the cutting mechanism is configured such that a single bandsaw blade simultaneously cuts the livestock feed at the two independent cutting zones.

16. A method as in claim 14, wherein the cutting mechanism is configured such that a separate bandsaw blade cuts the livestock feed at each independent cutting zone.

17. A method as in claim 14, wherein the cutting mechanism includes at least two roller wheels around which the bandsaw blade revolves, said roller wheels being disposed outside the cutting zones.

18. A method as in claim 17, wherein the cutting mechanism further includes a mechanical comb present between the roller wheels and the cutting zone, said mechanical comb being configured to reduce or prevent contact between the livestock feed and the roller wheels.

19. A method as in claim 14, wherein the bandsaw blade is guided by a plurality of mechanical guides which help maintain the bandsaw blade in the cutting zone.

20. A method as in claim 19, wherein the mechanical guides are supported by a supporting member which runs parallel to the bandsaw blade in each of the cutting zones.

21. An apparatus as in claim 1, wherein the cutting mechanism includes three independent cutting zones.
